(19) United States
(12) Patent Application Publication
(10) Pub. No.: US 2025/0055050 A1
(43) Pub. Date: Feb. 13, 2025

(54) BATTERY SYSTEM FOR AN ELECTRIC VEHICLE AND METHOD FOR DETERMINATION OF A THERMAL RUNAWAY

(71) Applicant: SAMSUNG SDI CO., LTD., Yongin-si (KR)

(72) Inventor: Eymen IPEK, Graz (AT)

(21) Appl. No.: 18/742,020

(22) Filed: Jun. 13, 2024

(30) Foreign Application Priority Data
Aug. 7, 2023 (EP) 23190029.1

(51) Int. Cl. H01M 10/48; B60L 3/00; H01M 10/42; H01M 50/204; H01M 50/249

(52) U.S. Cl. CPC H01M 10/482; B60L 3/0046; H01M 10/425; H01M 50/204; H01M 50/249; H01M 2010/4271; H01M 2010/4278; H01M 2200/20; H01M 2220/20

(57) ABSTRACT

A electric vehicle battery system includes a battery pack including battery cells accommodated within a housing and a thermal runaway detection system including a sensor unit transmitting data and a control unit receiving data therefrom, the sensor unit positioned within the battery pack and including a first cover and a second cover arranged on/connected to the first cover element to form a space therebetween, a light emitter and a light sensor arranged within the space such that light emitted from the light emitter is receivable at the light sensor via a light path that extends across the space, and the first cover element is designed to bend towards the second cover element and into the light path if a pressure in the battery pack increases, the control unit configured to detect thermal runaway based on a change in transmitted data.

### CROSS-REFERENCE TO RELATED APPLICATION

European Patent Application No. 23190029.1, filed on Aug. 7, 2023, in the European Patent Office, is incorporated by reference herein in its entirety.

### BACKGROUND

### 1. Field

Embodiments relate to a battery system for an electric vehicle, an electric vehicle including the same, and a method for determination of a thermal runaway in the battery system.

### 2. Description of the Related Art

Recently, vehicles for transportation of goods and people have been developed that use electric power as a source for motion. Such an electric vehicle is an automobile that is propelled permanently or temporarily by an electric motor, using energy stored in rechargeable batteries. An electric vehicle may be solely powered by batteries (Battery Electric Vehicle BEV) or may include a combination of an electric motor and, for example, a conventional combustion engine (Plugin Hybrid Electric Vehicle PHEV). BEVs and PHEVs use high-capacity rechargeable batteries, which are designed to give power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located in a casing and electrode terminals, which are positioned on the outside of the casing, establish an electrically conductive connection to the electrodes. The shape of the casing may be, for example, cylindrical or rectangular.

A battery module is formed of a plurality of battery cells connected in series or in parallel. That is, the battery module is formed by interconnecting the electrode terminals of the plurality of battery cells depending on a required amount of power and in order to realize a high-power rechargeable battery.

A battery pack is a set of any number of (for example identical) battery modules or single battery cells. The battery modules, respectively battery cells, may be configured in a series, parallel or a mixture of both to deliver the desired voltage, capacity, and/or power density. Components of a battery pack include the individual battery modules, and the interconnects, which provide electrical conductivity between the battery modules.

A battery system may also include a battery management system (BMS), which is any suitable electronic system that is configured to manage the rechargeable battery cell, battery module, and battery pack, such as by protecting the batteries from operating outside their safe operating range, monitoring their states, calculating secondary data, reporting that data, controlling its environment, authenticating it and/or balancing it.

An active or passive thermal management system may be included to provide thermal control of the battery pack, to safely use the at least one battery module by efficiently emitting, discharging, and/or dissipating heat generated from its rechargeable batteries. If the heat emission/discharge/dissipation is not sufficiently performed, temperature deviations may occur between respective battery cells, such that the at least one battery module may no longer generate a desired (or designed) amount of power. In addition, an increase of the internal temperature can lead to abnormal reactions occurring therein, and thus charging and discharging performance of the rechargeable battery deteriorates and the life-span of the rechargeable battery is shortened. Thus, cell cooling for effectively emitting/discharging/dissipating heat from the cells is required.

Exothermic decomposition of cell components may lead to a so-called thermal runaway. Generally, thermal runaway describes a process that accelerates due to increased temperature, in turn releasing energy that further increases the temperature. Thermal runaway occurs in situations where an increase in temperature changes the conditions in a way that causes a further increase in temperature, often leading to a destructive result. In rechargeable battery systems, thermal runaway is associated with strong exothermic reactions that are accelerated by temperature rise. In thermal runaway, the battery cell temperature rises incredibly fast and the energy stored is released very suddenly. In extreme cases, thermal runaway can cause battery cells to explode and start fire. In minor cases, it can cause battery cells to be damaged beyond repair.

If a battery cell is heated above a critical temperature (for example, above 150° C.) the battery cell can transition into a thermal runaway. Generally, temperatures outside of the safe region on either the low or high side may lead to irreversible damage to the battery cell and therefore may possible trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding 700° C. Further, large quantities of hot gas are ejected from inside of the failed battery cell through the venting opening of the cell housing into the battery pack. The main components of the vented gas are H₂, CO₂, CO, electrolyte vapor and other hydrocarbons. The vented gas is therefore flammable and potentially toxic. The vented gas also causes a gas-pressure to increase inside the battery pack. In the worst case, the high temperatures lead to the process spreading to neighboring cells and fire in the battery pack. At this stage, the fire is difficult to extinguish.

If the BMS detects that the temperature is too hot, it can regulate the temperature by controlling cooling fans, for example. Alternatively, if the battery cell cannot be cooled and safe conditions restored, the BMS may shut down necessary battery cells to protect the entire system.

To prevent or detect thermal runaway, additional sensor systems for predicting or confirming critical states in the battery system are desirable in addition to the known conventional temperature monitoring.

### SUMMARY

Embodiments include a battery system for an electric vehicle. The battery system includes a battery pack including a plurality of battery cells accommodated within a housing and a thermal runaway detection system including a sensor unit and a control unit, the sensor unit and control unit being configured for transmitting and receiving data from the sensor unit to the control unit, wherein the sensor unit is positioned within the battery pack of the battery system. The sensor unit includes a first cover element and a second cover element arranged on and connected to the first cover element in such a way that a space is formed between the first cover element and second cover element, a light emitter and a light sensor arranged within the space such that light emitted from the light emitter is receivable at the light sensor via a light path that extends across the space and the first cover element is designed to bend towards the second cover element and into the light path if there is a pressure increase in the battery pack, wherein the control unit is configured to detect a possible thermal runaway based on a change in data transmitted by the sensor unit.

The second cover element of the sensor unit may be a part of the housing, a part of a carrier framework or a part of an outer cover sealing of the battery pack.

The control unit may be integrated into a battery management system, BMS, of the battery system.

The control unit may be configured to determine a rapidity and/or height of the pressure increase within the battery pack based on the data transmitted from the sensor unit and to evaluate a possibility of a thermal runaway based thereon.

The light emitter of the sensor unit may be an LED emitting infrared light.

The light sensor may be a photo diode.

An electric vehicle including a battery system. The battery system includes a battery pack including a plurality of battery cells accommodated within a housing and a thermal runaway detection system including a sensor unit and a control unit, the sensor unit and control unit being configured for transmitting and receiving data from the sensor unit to the control unit, wherein the sensor unit is positioned within the battery pack of the battery system. The sensor unit includes a first cover element and a second cover element arranged on and connected to the first cover element in such a way that a space is formed between the first cover element and second cover element, a light emitter and a light sensor arranged within the space such that light emitted from the light emitter is receivable at the light sensor via a light path that extends across the space and the first cover element is designed to bend towards the second cover element and into the light path in the event of a pressure increase in the battery pack, wherein the control unit is configured to detect a possible thermal runaway based on a change in data transmitted by the sensor unit.

The control unit may be integrated into a battery management system, BMS, of the battery system and the second cover element of the sensor unit may be a part of the housing, a part of a carrier framework or a part of an outer cover sealing of the battery pack.

The control unit may be configured to determine a rapidity and/or height of the pressure increase within the battery pack based on the data transmitted from the sensor unit and to evaluate the possibility of a thermal runaway based thereon, and the second cover element of the sensor unit may be a part of the housing, a part of a carrier framework or a part of an outer cover sealing of the battery pack.

The control unit may be configured to determine a rapidity and/or height of the pressure increase within the battery pack based on the data transmitted from the sensor unit and to evaluate a possibility of a thermal runaway based thereon, and the control unit may be integrated into a battery management system of the battery system.

The light emitter of the sensor unit may be an LED emitting infrared light, and the second cover element of the sensor unit may be a part of the housing, a part of a carrier framework or a part of an outer cover sealing of the battery pack.

The light emitter of the sensor unit is an LED emitting infrared light, and the control unit may be integrated into a battery management system of the battery system.

The light emitter of the sensor unit may be an LED emitting infrared light, and the control unit may be configured to determine a rapidity and/or height of the pressure increase within the battery pack based on the data transmitted from the sensor unit and to evaluate a possibility of a thermal runaway based thereon.

The light sensor may be a photo diode, and the second cover element of the sensor unit may be a part of the housing, a part of a carrier framework or a part of an outer cover sealing of the battery pack.

The light sensor may be a photo diode, and the control unit may be integrated into a battery management system of the battery system.

The light sensor may be a photo diode, and the control unit may be configured to determine a rapidity and/or height of the pressure increase within the battery pack based on the data transmitted from the sensor unit and to evaluate a possibility of a thermal runaway based thereon.

An electric vehicle including a battery system. The battery system includes a battery pack including a plurality of battery cells accommodated within a housing and a thermal runaway detection system including a sensor unit and a control unit, the sensor unit and control unit being configured for transmitting and receiving data from the sensor unit to the control unit, wherein the sensor unit is positioned within the battery pack of the battery system. The sensor unit includes a first cover element and a second cover element arranged on and connected to the first cover element in such a way that a space is formed between the first cover element and second cover element, a light emitter and a light sensor arranged within the space such that light emitted from the light emitter is receivable at the light sensor via a light path that extends across the space and the first cover element is designed to bend towards the second cover element and into the light path in the event of a pressure increase in the battery pack, wherein the control unit is configured to detect a possible thermal runaway based on a change in data transmitted by the sensor unit, wherein the second cover element of the sensor unit is a part of the housing, a part of a carrier framework or a part of an outer cover sealing of the battery pack.

An electric vehicle including a battery system. The battery system includes a battery pack including a plurality of battery cells accommodated within a housing and a thermal runaway detection system including a sensor unit and a control unit, the sensor unit and control unit being configured for transmitting and receiving data from the sensor unit to the control unit, wherein the sensor unit is positioned within the battery pack of the battery system. The sensor unit includes a first cover element and a second cover element arranged on and connected to the first cover element in such a way that a space is formed between the first cover element and second cover element, a light emitter and a light sensor arranged within the space such that light emitted from the light emitter is receivable at the light sensor via a light path that extends across the space and the first cover element is designed to bend towards the second cover element and into the light path in the event of a pressure increase in the battery pack, wherein the control unit is configured to detect a possible thermal runaway based on a change in data transmitted by the sensor unit, wherein the control unit is integrated into a battery management system of the battery system.

Embodiments include a method for determination of thermal runaway in a battery system for an electric vehicle. The method includes a) providing a battery system. The battery system includes a battery pack including a plurality of battery cells accommodated within a housing and a thermal runaway detection system including a sensor unit and a control unit, the sensor unit and control unit being configured for transmitting and receiving data from the sensor unit to the control unit, wherein the sensor unit is positioned within the battery pack of the battery system and includes a first cover element and a second cover element arranged on and connected to the first cover element in such a way that a space is formed between the first cover element and second cover element, a light emitter and a light sensor arranged within the space such that light emitted from the light emitter is receivable at the light sensor via a light path that extends across the space and the first cover element is designed to bend towards the second cover element and into the light path if there is a pressure increase in the battery pack. The method also includes b) detecting a possible thermal runaway by the control unit based on a change in data transmitted by the sensor unit.

The control unit may determine a rapidity and/or height of the pressure increase within the battery pack based on the data transmitted from the sensor unit and evaluates a possibility of a thermal runaway based thereon.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic cross section (block diagram) of a battery system according to one or more embodiments of the present disclosure;

FIG. 2 illustrates a schematic sectional view a sensor unit in a first stage according to one or more embodiments of the present disclosure;

FIG. 3 shows the sensor unit of FIG. 2 in a second stage according to one or more embodiments of the present disclosure; and

FIG. 4 illustrates a flowchart of a method according to one or more embodiments of the present disclosure for determination of a thermal runaway in a battery system.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present.

Reference will now be made in detail to embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those of ordinary skill in the art.

Accordingly, processes, elements, and techniques that are not considered necessary to those having ordinary skill in the art for a complete understanding of the aspects and features of the present disclosure may not be described.

As used herein, the term “and/or” includes any and all combinations of one or more of the associated listed items. Further, the use of “may” where describing embodiments of the present disclosure refers to “one or more embodiments of the present disclosure.” In the following description of embodiments of the present disclosure, the terms of a singular form may include plural forms unless the context clearly indicates otherwise.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like.

Embodiments relate to a battery system for an electric vehicle. The battery system includes a battery pack including a plurality of battery cells accommodated within a housing. The battery system further includes a thermal runaway detection system including a sensor unit and a control unit. The sensor unit and control unit are configured for transmitting and receiving data from the sensor unit to the control unit. The sensor unit is positioned within the battery pack of the battery system and includes a first cover element and a second cover element arranged on and connected to the first cover element in such a way that a space is formed between the first cover element and second cover element, a light emitter and a light sensor arranged within the space such that light emitted from the light emitter is receivable at the light sensor via a light path that extends across the space; and the first cover element is designed to bend towards the second cover element and into the light path in the event of a pressure increase in the battery pack (caused by the release of gases in the event of a thermal runaway). The control unit is configured to detect a possible thermal runaway based on a change in data transmitted by the sensor unit (due to an interruption or reduction of the light detected via the light path at the light sensor).

The gist of the embodiments is a system and method to easily detect a condition of the battery pack indicating a thermal runaway of at least one of the battery cells. Therefore, the battery system is equipped with a thermal runaway detection system. As already stated above, failures of battery cells (for example, solid or liquid lithium-ion rechargeable batteries) being used for propulsion of vehicles may lead to thermal runaway. For example, temperatures outside of the safe region on either the low or high side may lead to irreversible damage to the battery cell and therefore may possibly trigger thermal runaway. Thermal runaway may also occur due to an internal or external short circuit of the battery cell or poor battery maintenance. For example, overcharging or rapid charging may lead to thermal runaway. As a consequence, large quantities of hot gas may be ejected from inside of the failed battery cell through the venting opening of the housing into the battery pack. The process takes place in a very short time, so that considerable volumes of gas are released. However, conventional battery packs only allow a controlled exchange of gas with the environment in a few places. As a consequence, a pressure within the battery pack may suddenly rise. With embodiments herein, such pressure and can be detected by the thermal runaway detection system.

The thermal runaway detection system includes a sensor unit and a control unit. The sensor unit and control unit are configured for transmitting and receiving data from the sensor unit to the control unit. Thus, measured data recorded by the sensor unit are transmitted to the control unit. The transmission may take place via data line or wireless, e.g. via a WLAN or Bluetooth interface. The communication between the sensor unit and the control unit may be bidirectional and may include further data and controlling signals. For example, the sensor unit may send information on its operating status on request of the control unit or send a defect message in case of failure.

The sensor unit is positioned within the battery pack of the battery system. The sensor unit may be installed inside the battery pack in such a way that an increase of pressure due to any gases released during thermal runaway can be detected immediately, yet, damage to the sensor unit by the gases can be avoided. The expert may find suitable positions in the battery pack on the basis of the expected distribution pattern of the gas.

The sensor unit provides a kind of measurement chamber (i.e. the space between the first cover element und the second cover element) that may be shielded and hermetically sealed for optical measurements. One wall of the measurement chamber (i.e. the first cover element) is designed in such a way that the wall can be bent towards the inside of the measurement chamber. The force to be applied for the mechanical deformation of the wall corresponds to an expected pressure increase at thermal runaway. The first cover element may have elastic properties so that it can return to its original position if the pressure drops. For example, the first cover element may be formed of an elastic polymer or a thin metal sheet.

The second cover element (or the other wall of the measurement chamber), on the other hand, is dimensionally stable to a pressure change inside the battery pack, so it will not bend in the case of thermal runaway. For example, the second cover element may be formed of a rigid metal sheet.

According to one or more embodiments, the second cover element of the sensor unit may be part of the housing, a part of a carrier framework or a part of an outer cover sealing of the battery pack. The housing and support structure of a battery pack may be formed from a solid metallic material, for example, extruded aluminum, to protect the battery cell from massive mechanical impact in the event of an accident. The housing and the support structure may have planar surfaces that can serve as a second cover element for the sensor unit. Similarly, a portion of an inner surface of the outer cover may be used as a second cover element. The outer cover shields the battery pack on the bottom if mounted on the vehicle and may also have a metallic wall that is pressure resistant. In this case, the light emitter, light sensor and the first cover element can be easily attached to the provided surface of said components. This may be done, for example, using an adhesive.

Within the measurement chamber (or space), a light emitter and a light sensor are placed. The light emitter and the light sensor are aligned with each other in such a way that the emitted light can be detected by the light sensor. The light path to be bridged by the light is not blocked under normal pressure conditions in the battery pack. As the pressure increases, the first cover element bending into the light path interrupts or reduces the light transmission from the light emitter to the light sensor. The light emitter and light sensor can be supplied with power via the battery pack or another external energy source (e.g. the vehicle's electrical system).

According to one or more embodiments, the light emitter of the sensor unit may be an LED emitting infrared light. Such light sources have proven to be suitable for the application and are also highly cost-effective. The overall height of LEDs is also particularly low, so that the overall height of the sensor unit can be kept relatively low.

According to one or more other embodiments, the light sensor may be a photo diode. Photo diodes are highly cost-effective, of low overall height and are suitable for the intended application in a battery system.

The control unit is preferably configured to detect a possible thermal runaway based on a change in data transmitted by the sensor unit due to an interruption or reduction of the light detected via the light path at the light sensor. The data may be transmitted continuously, at regular intervals or depending on certain operating states of the battery system. In other words, the control unit evaluates the data transmitted by the sensor unit.

According to one or more embodiments, the control unit may be configured to determine a rapidity and/or height of the pressure increase within the battery pack based on the data transmitted from the sensor unit and may be further configured to evaluate the possibility of a thermal runaway based thereon. Details will be provided below with respect to the corresponding method for determination of a thermal runaway in the battery system.

According to one or more other embodiments, the control unit may be integrated into a battery management system (BMS) of the battery system. As mentioned above, the BMS is any electronic system that manages the battery cells, battery module and battery pack, such as by protecting the battery cells, battery modules and battery pack from operating outside their safe operating range, monitoring their states, calculating secondary data, reporting that data, controlling its environment, authenticating it and/or balancing it. Making the knowledge gained via the control unit available to the BMS and using it to control the battery system is therefore a clear advantage.

Embodiments include a method for determination of thermal runaway in a battery system for an electric vehicle. The method includes providing a battery system as described above and detecting a possible thermal runaway by the control unit based a change in sensor data.

The battery system may further include a thermal runaway detection system including a sensor unit and a control unit, the sensor unit and control unit being configured for transmitting and receiving data from the sensor unit to the control unit.

The sensor unit may be positioned within the battery pack of the battery system and may include the following features: a first cover element and a second cover element arranged on and connected to the first cover element in such a way that a space is formed between the first cover element and second cover element; a light emitter and a light sensor arranged within the space such that light emitted from the light emitter is receivable at the light sensor via a light path that extends across the space; and at least the first cover element is designed to bend towards the second cover element and into the light path in the event of a pressure increase in the battery pack.

Thus, the method allows detection of a potential thermal runaway in the battery system of an electric vehicle. If, for example, the evaluation of the transmitted data shows a significant increase of pressure within the battery pack, the control unit may indicate a potential occurrence of thermal runaway.

If the first cover element fully interrupts the light path, the control unit may be configured to directly indicate the presence of a thermal runaway. However, if the first cover element is only partly blocking the light path due to an increase of internal pressure in the battery pack, the control unit may only indicate the possibility of occurrence of thermal runaway and initiate further diagnostic routines. In that case, the control unit may, for example, determine a rapidity and/or height of the pressure increase within the battery pack based on the data transmitted from the sensor unit and evaluate the possibility of thermal runaway based thereon. For practical implementation, a characteristic curve for increase of pressure in case of thermal runaway may be stored in a memory of the control unit and compared with the course of pressure transmitted by the sensor unit. Alternatively or in addition, the control unit may be configured to indicate the possibility of thermal runaway if a change in data representing an increase of pressure over a distinct time period exceeds a certain threshold value. The characteristic curve or threshold values must be defined individually for the respective battery pack.

In addition, the control unit may start additional routines to clarify the safety status of the battery pack, for example, evaluation of temperature data measured in the battery pack. Furthermore, the control unit may initiate counter measures, for example, activation of cooling means.

Exemplary embodiments will now be described with reference to the drawings.

FIG. 1 is a schematic cross section in block diagram form of a battery system 100 according to one or more embodiments of the present disclosure. In the depicted example, two battery modules 20a, 20b are accommodated within a housing 15 of a battery pack 10. Each of the battery modules 20a, 20b may include a plurality of battery cells 30 (e.g., lithium-ion rechargeable battery cells). A single battery cell 30a may, under unfavorable circumstances, switch to a faulty operating state known as thermal runaway, which leads to the release of considerable quantities of hot gas within a very short time. The gas usually escapes abruptly at an upper side of the battery cell 30a, as there is usually a pressure relief valve in the battery cell's case (location of release is labelled with a star). The battery modules 20a, 20b are controlled and monitored by and thus connected via cable-connections 25a, 25b with a battery management system, BMS, 40.

The battery system 100 may further include a thermal runaway detection system 200 including a sensor unit 210 and a control unit 250. The sensor unit 210 may be controlled and monitored by and connected via a cable-connection 25c with the control unit 250. Thus, measurement data can be transmitted from the sensor unit 210 to the control unit 250. The communication between the sensor unit 210 and the control unit 250 may be bidirectional and may include further data and controlling signals. For example, the sensor unit 210 may send information on its operating status on request of the control unit 250 or send a defect message in case of failure.

The sensor unit 210 is positioned within the battery pack 10 of the battery system 100. According to FIG. 1, the sensor unit 210 is installed inside the battery pack 10 at an inner surface of the housing 15. The position of the sensor unit 210 may be selected such that hot gases released from any defect battery cell 30a do not directly hit the sensor unit 210 so as to avoid damage. In addition, the position may also be chosen so that a change in pressure inside the battery pack 10 is immediately detected.

In some embodiments, the control unit 250 may be integrated into the BMS 40. The data obtained by the control unit 250 from the measurement data of the sensor unit 210 can thus be processed directly by the BMS 40.

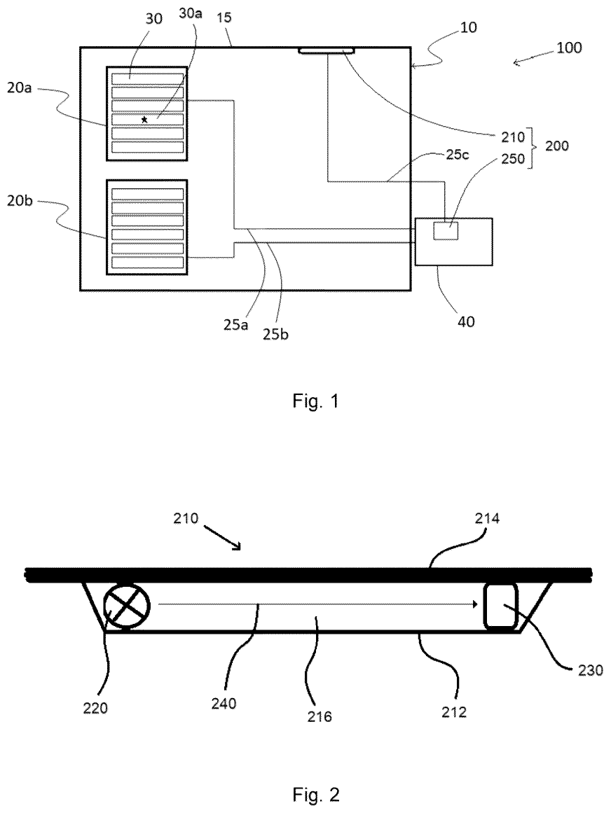

FIG. 2 shows in a schematic sectional view the sensor unit 210 in a first stage, which can be used in the battery system 100 of FIG. 1 according to one or more embodiments. The sensor unit 210 may include a first cover element 212 and a second cover element 214. The second cover element 214 may be arranged on and connected to the first cover element 212 in such a way that a space 216 is formed between the first cover element 212 and second cover element 214. A light emitter 220 and a light sensor 230 may be arranged within the space 216 such that light 240 emitted from the light emitter 220 is receivable at the light sensor 230 via a light path that extends across the space 216. In FIG. 2, the light emitter 220 may be an LED emitting infrared light and the light sensor 230 may be a photo diode being sensible for infrared light.

The first cover element 212 may be designed to bend towards the second cover element 214 and into the light path in the event of a pressure increase in the battery pack 10. To ensure the function, the first cover element 212 may be, for example, a membrane made of an elastomeric material. Preferably, the second cover element 214 does not exhibit elastic behavior if pressure rises inside the battery pack 10. In some embodiments, the second cover element 214 may be a part of the housing 15, for example, a part of the housing 15 showing a planar inner surface. It is also conceivable that a part of a carrier framework (not shown) or a part of an outer cover sealing of the battery pack 10 (not shown) may form the second cover element 214. In other embodiments, the second cover element 214 may be implemented as an independent structural element of the sensor unit 210.

The sensor unit 210 may be in the first stage if the internal pressure within the battery pack 10 is within a range for normal operation. The light 240 emitted by the light emitter 220 may fall on the light sensor 230 in a direct path and unobstructed. A signal corresponding to the amount of light received may be transmitted from the light sensor 230 to the control unit 250.

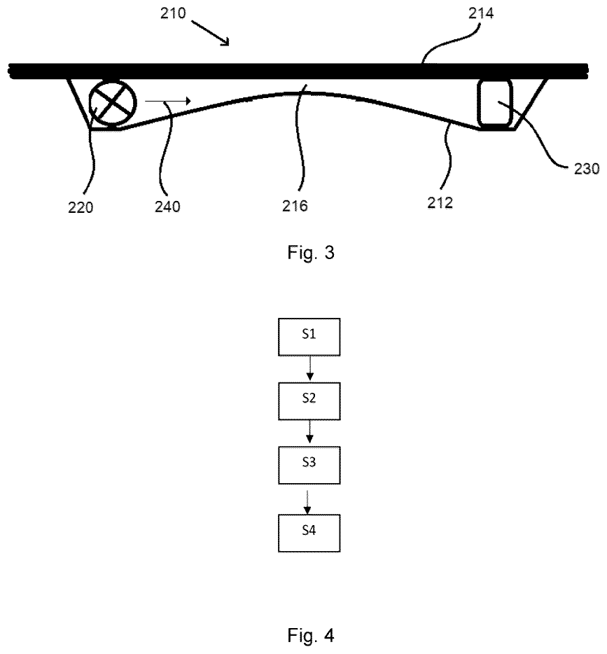

FIG. 3 shows the sensor unit 210 of FIG. 2 in a second stage according to one or more embodiments. Due to an increase of the internal pressure within the battery pack 10, the first cover element 212 is bent towards the second cover element 214 and blocks the light path. As a consequence, the light 240 emitted from the light emitter 220 cannot directly reach the light sensor 230. Accordingly, there is a significant change to the measured data of the light sensor 230 transmitted to the control unit 250. If the first cover element 212 touches the second cover element 214, no light 240 may fall on the light sensor 230 anymore. An increase of the internal pressure within the battery pack 10 may be a result of a thermal runaway of the failed battery cell 30a.

The control unit 250 may be configured to detect a possible thermal runaway based on a change in data transmitted by the sensor unit 210.

FIG. 4 illustrates a flowchart of a method according to one or more embodiments of the present disclosure for determination of thermal runaway in the battery system 100.

In a first step S1 of the method, a battery system 100 as described in the previous sections is provided.

In a second step S2, the amount of light 240 received at the light sensor 230 may be measured and carried out in the sensor unit 210, for example, the measuring may be continuous. The measured data may then be transmitted to the control unit 250. The data may be transmitted continuously, at regular intervals or may depend on certain operating states of the battery system 100.

In step S3, detecting a possible thermal runaway may be carried out by the control unit 250 based on a change in data transmitted by the sensor unit 210. If no change in data is detected by the control unit 250, there is likely no thermal runaway. However, if the first cover element 212 fully interrupts the light path, the control unit 250 may directly indicate the presence of a thermal runaway.

In case the light path is only partly blocked by the bended first cover element 212 (for example, as illustrated in FIG. 3), the control unit 250 may evaluate a rapidity and/or height of the pressure increase within the battery pack 10 based on the data transmitted from the sensor unit 210 and may evaluate the possibility of thermal runaway based thereon. In some embodiments, a characteristic curve for increase of pressure in case of thermal runaway may be stored in a memory of the control unit 250. The stored characteristic curve may be compared with the course of pressure transmitted by the sensor unit 210. If the course of the curve is the same, the control unit 250 may indicate the possibility of the occurrence of thermal runaway.

In step S4, the control unit 250 generates a corresponding status message to the BMS 40. The BMS 40 may start additional routines to clarify the safety status of the battery pack 10, for example, evaluation of temperature data measured in the battery pack 10. Furthermore, the BMS 40 may initiate counter measures, for example, activation of a cooling element. Further safety measures may also be started by the BMS 40. For example, the vehicle can be automatically stopped, a cooling system and/or a fire-extinguishing system can be started. Also, warning signals can be triggered inside the passenger compartment of the vehicle.

In embodiments, the BMS may monitor the state of the battery cell as represented by voltage (e.g., a total voltage of the battery pack or battery modules, and/or voltages of individual battery cells), temperature (e.g., an average temperature of the battery pack or battery modules, coolant intake temperature, coolant output temperature, or temperatures of individual battery cells), coolant flow (e.g., flow rate and/or cooling liquid pressure), and current. Additionally, the BMS may calculate values based on the above parameters, such as minimum and maximum cell voltage, state of charge (SOC) or depth of discharge (DOD) to indicate the charge level of the battery cell, state of health (SOH; a variously-defined measurement of the remaining capacity of the battery cell as % of the original capacity), state of power (SOP; the amount of power available for a defined time interval given the current power usage, temperature and other conditions), state of safety (SOS), maximum charge current as a charge current limit (CCL), maximum discharge current as a discharge current limit (DCL), and internal impedance of a cell (to determine open circuit voltage).

In some embodiments, the BMS may be centralized such that a single controller is connected to the battery cells through a multitude of wires. In other embodiments, the BMS may be distributed, with a BMS board is installed at each cell, with just a single communication cable between the battery cell and a controller. In still other embodiments, the BMS may have a modular construction including a few controllers, each handling a certain number of cells, while communicating between the controllers. Centralized BMSs are most economical, but are least expandable, and are plagued by a multitude of wires. Distributed BMSs are the most expensive, but are simplest to install, and offer the cleanest assembly. Modular BMSs provide a compromise of the features and problems of the other two topologies.

The BMS may protect the battery pack from operating outside its safe operating range. Operation outside the safe operating range may be indicated by over-current, over-voltage (during charging), over-temperature, under-temperature, over-pressure, and ground fault or leakage current detection. The BMS may prevent the battery from operating outside its safe operating parameter by including an internal switch (e.g., a relay or solid-state device) that opens if the battery is operated outside its safe operating parameters, requesting the devices to which the battery is connected to reduce or even terminate using the battery, and actively controlling the environment, such as through heaters, fans, air conditioning or liquid cooling.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### REFERENCE NUMBERS

10 battery pack
15 housing
20a, 20b battery modules
25a, 25b, 25c cable-connections
30 battery cells
30a defect battery cell
40 battery management system BMS
100 battery system
200 thermal runaway detection system
210 sensor unit
212 first cover element
214 second cover element
216 space
220 light emitter
230 light sensor
240 light

What is claimed is:

1. A battery system for an electric vehicle, the system comprising:
a battery pack comprising a plurality of battery cells accommodated within a housing and a thermal runaway detection system comprising a sensor unit and a control unit, the sensor unit and control unit being configured for transmitting and receiving data from the sensor unit to the control unit, wherein the sensor unit is positioned within the battery pack of the battery system and comprises:
a first cover element and a second cover element arranged on and connected to the first cover element in such a way that a space is formed between the first cover element and second cover element;
a light emitter and a light sensor arranged within the space such that light emitted from the light emitter is receivable at the light sensor via a light path that extends across the space; and
the first cover element is designed to bend towards the second cover element and into the light path in the event of a pressure increase in the battery pack; and
wherein the control unit is configured to detect a possible thermal runaway based on a change in data transmitted by the sensor unit.

2. The battery system as claimed in claim 1, wherein the second cover element of the sensor unit is a part of the housing, a part of a carrier framework or a part of an outer cover sealing of the battery pack.

3. The battery system as claimed in claim 1, wherein the control unit is integrated into a battery management system of the battery system.

4. The battery system as claimed in claim 1, wherein the control unit is configured to determine a rapidity and/or height of the pressure increase within the battery pack based on the data transmitted from the sensor unit and to evaluate the possibility of a thermal runaway based thereon.

5. The battery system as claimed in claim 1, wherein the light emitter of the sensor unit is an LED emitting infrared light.

6. The battery system as claimed in claim 1, wherein the light sensor is a photo diode.

7. An electric vehicle comprising the battery system as claimed in claim 1.

8. The battery system as claimed in claim 1, wherein the control unit is integrated into a battery management system of the battery system and wherein the second cover element of the sensor unit is a part of the housing, a part of a carrier framework or a part of an outer cover sealing of the battery pack.

9. The battery system as claimed in claim 1, wherein the control unit is configured to determine a rapidity and/or height of the pressure increase within the battery pack based on the data transmitted from the sensor unit and to evaluate the possibility of a thermal runaway based thereon, wherein the second cover element of the sensor unit is a part of the housing, a part of a carrier framework or a part of an outer cover sealing of the battery pack.

10. The battery system as claimed in claim 1, wherein the control unit is configured to determine a rapidity and/or height of the pressure increase within the battery pack based on the data transmitted from the sensor unit and to evaluate the possibility of a thermal runaway based thereon, and wherein the control unit is integrated into a battery management system of the battery system.

11. The battery system as claimed in claim 1, wherein the light emitter of the sensor unit is an LED emitting infrared light, and wherein the second cover element of the sensor unit is a part of the housing, a part of a carrier framework or a part of an outer cover sealing of the battery pack.

12. The battery system as claimed in claim 1, wherein the light emitter of the sensor unit is an LED emitting infrared light, and wherein the control unit is integrated into a battery management system of the battery system.

13. The battery system as claimed in claim 1, wherein the light emitter of the sensor unit is an LED emitting infrared light, and wherein the control unit is configured to determine a rapidity and/or height of the pressure increase within the battery pack based on the data transmitted from the sensor unit and to evaluate the possibility of a thermal runaway based thereon.

14. The battery system as claimed in claim 1, wherein the light sensor is a photo diode, and wherein the second cover element of the sensor unit is a part of the housing, a part of a carrier framework or a part of an outer cover sealing of the battery pack.

15. The battery system as claimed in claim 1, wherein the light sensor is a photo diode, and wherein the control unit is integrated into a battery management system of the battery system.

16. The battery system as claimed in claim 1, wherein the light sensor is a photo diode, and wherein the control unit is configured to determine a rapidity and/or height of the pressure increase within the battery pack based on the data transmitted from the sensor unit and to evaluate the possibility of a thermal runaway based thereon.

17. An electric vehicle comprising the battery system as claimed in claim 1, wherein the second cover element of the sensor unit is a part of the housing, a part of a carrier framework or a part of an outer cover sealing of the battery pack.

18. An electric vehicle comprising the battery system as claimed in claim 1, wherein the control unit is integrated into a battery management system of the battery system.

19. A method for determination of a thermal runaway in a battery system for an electric vehicle, wherein the method comprises the steps of:
a) providing a battery system, comprising:
a battery pack comprising a plurality of battery cells accommodated within a housing; and
a thermal runaway detection system comprising a sensor unit and a control unit, the sensor unit and control unit being configured for transmitting and receiving data from the sensor unit to the control unit,
wherein the sensor unit is positioned within the battery pack of the battery system and comprises:
a first cover element and a second cover element arranged on and connected to the first cover element in such a way that a space is formed between the first cover element and second cover element;
a light emitter and a light sensor arranged within the space such that light emitted from the light emitter is receivable at the light sensor via a light path that extends across the space; and
the first cover element is designed to bend towards the second cover element and into the light path in the event of a pressure increase in the battery pack; and
b) detecting a possible thermal runaway by the control unit based on a change in data transmitted by the sensor unit.

20. The method as claimed in claim 19, wherein the control unit determines a rapidity and/or height of the pressure increase within the battery pack based on the data transmitted from the sensor unit and evaluates the possibility of a thermal runaway based thereon.
